(19) United States
(12) Patent Application Publication
(10) Pub. No.: US 2021/0094254 A1
(43) Pub. Date: Apr. 1, 2021

(54) METHOD FOR MANUFACTURING ROOM TEMPERATURE SHRINKABLE TUBE USING WATER AND EXPANSION AGENT AND FLEXIBLE BUSBAR USING THE SAME

(71) Applicant: Seilhitech Co., Ltd., Gyeonggi-do (KR)

(72) Inventors: Mun-tae Park, Gyeonggi-do (KR); Byung-ju Park, Gyeonggi-do (KR)

(21) Appl. No.: 17/044,648

(22) PCT Filed: Nov. 27, 2019
(86) PCT No.: PCT/KR2019/016764

§ 371 Date: Oct. 1, 2020

(30) Foreign Application Priority Data
Nov. 29, 2018 (KR) 10-2018-0151091
Nov. 29, 2018 (KR) 10-2018-0151103
Mar. 21, 2019 (KR) 10-2019-0032602
Nov. 22, 2019 (KR) 10-2019-0151689

(51) Int. Cl. B32B 1/08; C08J 7/02; H01B 13/32; H01B 17/58; H01B 19/00; B32B 15/20; B32B 15/04; B32B 15/082; B32B 27/28; B32B 27/30

(52) U.S. Cl. CPC B32B 1/08; B32B 2274/00; H01B 13/32; H01B 17/58; H01B 19/00; B32B 15/20; B32B 15/043; B32B 15/082; B32B 27/283; B32B 27/306; B32B 2250/05; B32B 2307/202; B32B 2311/24; B32B 2311/12; B32B 2383/00; B32B 2331/04; C08J 7/02

(57) ABSTRACT

This invention relates to a method for manufacturing a room temperature shrinkable tube using water and an expansion agent and a flexible busbar using the same, and is constituted by including a busbar core 10 and a shrinkable tube 20 as main configurations. The shrinkable tube is expanded using an aqueous system of immersing and expanding the shrinkable tube in a solution mixed with water and an expansion agent for a predetermined time, the expanded shrinkable tube is naturally shrunk at room temperature and simply tubed on an outer circumferential surface of a busbar core to be insulated and coated, and in particular, the busbar core maintains the integrity with the shrinkable tube by a structure engaging with an intaglio-relief structure by a shrinkage force of the shrinkable tube so as to prevent deformation including lifting and wrinkling of the shrinkable tube when the shape of the busbar is deformed.

### FIELD OF THE INVENTION

The present invention relates to a method for manufacturing a room temperature shrinkable tube using water and an expansion agent and a flexible busbar using the same, and more particularly, to a method for manufacturing a room temperature shrinkable tube using water and an expansion agent and a flexible busbar using the same in which a shrinkable tube is expanded using an aqueous system of immersing and expanding the shrinkable tube in a solution consisting of a mixture of water and an expansion agent for a predetermined time, the expanded shrinkable tube is naturally shrunk at room temperature, and simply tubed, i.e., slid, onto an outer circumferential surface of a busbar core to be insulated and coated, and in particular, the busbar core maintains integrity with the shrinkable tube by engaging an intaglio-relief structure by the shrinkage force of the shrinkable tube so as to prevent deformation including lifting and wrinkling of the shrinkable tube when the shape of the busbar is deformed.

### BACKGROUND OF THE INVENTION

Recently, in many industrial fields, a shrinkable material has been frequently used for various purposes such as insulating and sealing, and the shrinkable material is a material in which an operation is easy due to an expanded state when being coated or inserted to an object to be used and the shrinkable material in the expanded state is shrunk and restored to an original state by an additional method after the object is inserted into the shrinkable material to form a tight and good sealing or insulating state on an object.

Recently, such a shrinkable material has been manufactured in the form of a tube to prevent contact accidents with transmission circuits such as large power distribution lines with large current capacity, conductors for electric devices, and communication cables in power plants, large buildings, large factories, large department stores, subways, and new airports and have been frequently used to insulate wires or busbars. The material of the tube has been frequently used with polyvinyl chloride (PVC) (abbreviated as PVC, or referred to as polyvinyl chloride or vinyl chloride resin) and polyethylenes of polymer materials.

Tubes applied to such wires or busbars have utilized various shrinkage methods, and include a heat shrinkable tube, an elastic shrinkable tube, an air shrinkable tube, etc. The heat shrinkable tube or a heat shrinkable material have been mainly used in various industries.

The heat shrinkable tube is a currently most practical shrinkable material which is maintained in an expansion state by heating a polymer to a melting point and cooling the heated polymer in an expanded state and then is shrunk to its original state by applying heat again when used. However, the heat shrinkable tube has problems in that, since a separate operation of applying heat during shrinkage is necessarily performed, there is inconvenience depending on an operating place, the operation of applying the heat increases costs, and the shrinkable material is not uniformly heated and may be damaged or deformed unless the heating operation is carried out by a skilled operator.

Related art to address the above problems is found in Korean Patent Registration No. 10-0817979 (issued on Mar. 24, 2008). This patent relates to a composition for producing a low temperature heat shrinkable tube and a low temperature heat shrinkable tube. There is disclosed a composition for producing a low temperature heat shrinkable tube which is able to be used for coating, packaging, etc. of products made of a material that may be degraded or deformed during a high temperature operation, such as a nylon-coated brake pipe and reduces a heat shrink temperature of the heat shrinkable tube by using a composition for producing a low temperature heat shrinkable tube comprising an ethylene-vinyl acetate copolymer resin having a vinyl acetate content of 20 to 33 wt % as a basic resin and comprising 0.5 to 3 parts by weight of an antioxidant consisting of a single material selected from the group of thioester-based and phenolic materials or mixtures thereof, and 1 to 5 parts by weight of a cyanurate-based crosslinking aid with respect to 100 parts by weight of the base resin.

However, in the related art, a temperature point of the heat shrinkable material for coating is lowered so that the heating operation to shrink the heat shrinkable material may be easy, but there is still the problem in that an additional operation for shrinkage may not be omitted.

Therefore, there is a need for a method of producing a room temperature shrinkable tube capable of naturally shrinking the shrinkable tube expanded by the expansion agent at room temperature even while being necessarily subjected to the operation of separately applying heat to shrink the shrinkable material or the shrinkable tube, and tightly sealing or insulating an object to be coated depending on the purpose for which the object to be coated is used.

### DETAILED DESCRIPTION

Therefore, the present invention is derived to solve the problems, and more specifically, an object of the present invention is to provide a method for manufacturing a room temperature shrinkable tube using water and an expansion agent and a flexible busbar using the same, in which a shrinkable tube is expanded using an aqueous system of immersing and expanding the shrinkable tube in a solution mixed with water and an expansion agent for a predetermined time, the expanded shrinkable tube is naturally shrunk at room temperature and simply tubed on an outer circumferential surface of a busbar core to be insulated and coated, and in particular, the busbar core maintains integrity with the shrinkable tube by an intaglio-relief structure engaged by a shrinkage force of the shrinkable tube to prevent deformation including lifting and wrinkling of the shrinkable tube when the shape of the busbar is deformed.

According to a preferred embodiment of the present invention, a flexible busbar using a room temperature shrinkable tube comprises a busbar core 10 formed by laminating and combining a plurality of copper plates and aluminum; and a shrinkable tube 20 which is provided to be tubed on an outer circumferential surface of the busbar core 10, expanded in a range without exceeding a predetermined expansion rate through an aqueous system using a saturated aqueous solution mixed with water and an expansion agent, and insulated and coated on the outer circumferential surface of the busbar core 10 while being shrunk and tubed at room temperature.

According to another embodiment of the present invention, the busbar core 10 may be constituted by a plurality of base plates 11, spacing plates 12 disposed between the base plates 11 and formed with smaller widths than the base plates 11, and intaglio band portions 11a formed between the base plates 11 due to a difference in lateral size between the base plates 11 and the spacing plates 12, and the shrinkable tube 20 has relief band portions 21 formed while an inner circumferential surface protrudes into the shapes of the intaglio band portions 11a while being shrunk, and the relief band portions 21 are combined to engage with the intaglio band portions 11a in a plurality of places.

According to yet another embodiment of the present invention, the busbar core 10 may be constituted by a plurality of base plates 11, arched spacing plates 13 disposed between the base plates 11 and formed in arch shapes with smaller widths than the base plates 11, and intaglio band portions 11a formed between the base plates 11 due to a difference in lateral size between the base plates 11 and the arched spacing plates 13, the shrinkable tube 20 has relief band portions 21 formed while an inner circumferential surface protrudes into the shape of the intaglio band portions 11a while being shrunk, and the relief band portions 21 are combined to engage with the intaglio band portions 11a in a plurality of places, and the base plates 11 are spaced apart from each other at extended gaps with respect to the thickness of the spacing plate 13 by an arched curvature of the arched spacing plate 13. When the busbar core 10 is pressed while the shrinkable tube 20 is shrunk, the gap between the base plates 11 is reduced while the spacing plate 13 is unfolded in a straight line, and due to the reduction in the gap between the base plates 11, the relief band portion 21 engaging with the intaglio band portion 11a is pressed and bound.

According to yet another embodiment of the present invention, the busbar core 10 may be formed by laminating a plurality of wedge-shaped plates 14 with inclined surfaces 14a formed on at least one surface, the wedge-shaped plates 14 are laminated so that the inclined surfaces 14a face each other in opposite directions, and the wedge-shaped plates 14 adjacent to each other in a vertical direction are disposed to be mismatched with each other in a width direction, so that intaglio band portions 11a are formed between the wedge-shaped plates 14, an inner circumferential surface protrudes into a shape of the intaglio band portion 11a while the shrinkable tube 20 is shrunk to form a relief band portion 21, the relief band portions 21 are coupled to engage with the intaglio band portions 11a in a plurality of places, and when the wedge-shaped plate 14 is pressed in both directions by the shrinkage force of the shrinkable tube 20, the expansion force acts in a thickness direction of the busbar core 10 by the inclined motion over the inclined surface 14a so that the wedge-shaped plate 14 is compressed on the inner circumferential surface of the shrinkable tube 20.

According to still another embodiment of the present invention, a method for manufacturing a room temperature shrinkable tube using water and an expansion agent to be coated on a flexible busbar comprises: the steps of: measuring a weight of the shrinkable tube 20 (S100); preparing the saturated aqueous solution in which a predetermined amount of the water and the expansion agent is mixed depending on the measured weight of the shrinkable tube 20 (S200); containing the saturated aqueous solution prepared in step S200 in a processing container (S300); further adding a predetermined additional amount of the expansion agent to the processing container in which the saturated aqueous solution is contained (S400); stirring and mixing the saturated aqueous solution and the additional amount of the expansion agent contained in the processing container to form floating materials (S500); expanding the shrinkable tube 20 through an aqueous system in a range without exceeding the predetermined expansion rate by containing the shrinkable tube 20 in the processing container and absorbing the expansion agent (S600); and inserting the busbar core 10 into the expanded shrinkable tube 20 and tubing the busbar core 10 with room temperature shrinkage to insulate and coat the tubed busbar core 10 (S800).

According to still another embodiment of the present invention, the step S600 may further comprise stirring and mixing the expansion agent in the floating material form to be absorbed in the shrinkable tube 20 immersed in the saturated aqueous solution in which the water and the expansion agent are mixed (S610).

According to still another embodiment of the present invention, in the step S400, 35 ml of silicon oil per 1 kg of the weight of the shrinkable tube 20 may be further added to the additional amount of the expansion agent to be added to the saturated aqueous solution.

According to still another embodiment of the present invention, the method may further comprise confirming that the expansion of the shrinkable tube 20 is completed by using the turbidity of the saturated aqueous solution in which an additional amount of expansion agent is mixed when the expansion of the shrinkable tube 20 is completed in the step S600 and taking out the shrinkable tube 20 in which the expansion is completed from the processing container.

According to still another embodiment of the present invention, in the step S700, when the shrinkable tube 20 needs to be further expanded at a predetermined expansion rate, the method may further comprise a step (S710) of further adding an expansion agent to the saturated aqueous solution so that the shrinkable tube 20 is further expanded and placing and expanding the shrinkable tube 20 in the saturated aqueous solution in which the additional expansion agent is added.

According to still another embodiment of the present invention, in the step S700, an amount X of the expansion agent to be additionally added to the saturated aqueous solution may be acquired using the following Equation

X=(0.96*Z)/Y−0.96

to have an expansion rate % Z at which the shrinkable tube 20 is further expanded at a predetermined expansion rate % Y.

According to still another embodiment of the present invention, in the saturated aqueous solution, as the expansion agent, any one of methylene chloride, ethyl acetate, and methyl ethyl ketone may be selected and used.

According to still another embodiment of the present invention, the saturated aqueous solution is 22 L per 1 kg of the shrinkable tube 20 and the expansion agent is 0.96 L per 1 kg of the shrinkable tube 20.

According to still another embodiment of the present invention, the saturated aqueous solution may be a saturated aqueous solution mixed with 94% of the water 1 and 6% of the expansion agent 2 based on the volume at room temperature of 24° C.

According to still another embodiment of the present invention, the predetermined expansion rate of the shrinkable tube 20 may not be more than 30%.

According to still another embodiment of the present invention, the shrinkable tube 20 may be formed by containing at least one of a thermoplastic elastomer (TPE), silicone, and an ethylene vinyl acetate copolymer (EVA).

Further, meanings of terms described in the present application should be understood as follows. The terms “first,” “second,”, and the like are used to differentiate a certain component from other components, but the scope of the present invention should not be construed to be limited by the terms. For example, a first component may be referred to as a second component, and similarly, the second component may be referred to as the first component.

It should be understood that, when it is described that a component is “connected to” the other component, the component may be directly connected to the other component or another component may be present therebetween. On the other hand, it should be understood that no component exists. Meanwhile, other expressions describing the relationship between the components, that is, expressions such as “between” and “directly between” or “adjacent to” and “directly adjacent to” should be similarly interpreted.

It is to be understood that the singular expression encompass plural expression unless the context clearly dictates otherwise and it should be understood that term “comprising” or “having” indicates that a feature, a number, a step, an operation, a component, a part or a combination thereof described in the specification is present, but does not exclude a possibility of presence or addition of one or more other features, numbers, steps, operations, components, parts or combinations thereof, in advance.

According to the above configurations and operations, more specifically, the present invention has effects in which a shrinkable tube is expanded using an aqueous system of immersing and expanding the shrinkable tube in a solution mixed with water and an expansion agent for a predetermined time, the expanded shrinkable tube is naturally shrunk at room temperature and simply tubed on an outer circumferential surface of a busbar core to be insulated and coated, and in particular, the busbar core maintains integrity with the shrinkable tube by an intaglio-relief structure engaged by a shrinkage force of the shrinkable tube to prevent deformation including lifting and wrinkling of the shrinkable tube when the shape of the busbar is deformed.

### BRIEF DESCRIPTION OF DRAWINGS

FIG. 1 is a schematic diagram illustrating a flexible busbar using a room temperature shrinkable tube according to an embodiment of the present invention.

FIG. 2 is a schematic diagram illustrating a flexible busbar using a room temperature shrinkable tube according to another embodiment of the present invention.

FIG. 3 is a schematic diagram enlarging and illustrating main parts of FIG. 2.

FIG. 4 is a schematic diagram illustrating a flexible busbar using a room temperature shrinkable tube according to another embodiment of the present invention.

FIG. 5 is a schematic diagram illustrating a state in which the flexible busbars using the shrinkable tubes of FIGS. 1, 2, and 4 are bent and formed.

FIGS. 6 to 8 are flowcharts schematically illustrating a method for manufacturing a room temperature shrinkable tube using water and an expansion agent according to the present invention.

### DETAILED DESCRIPTION

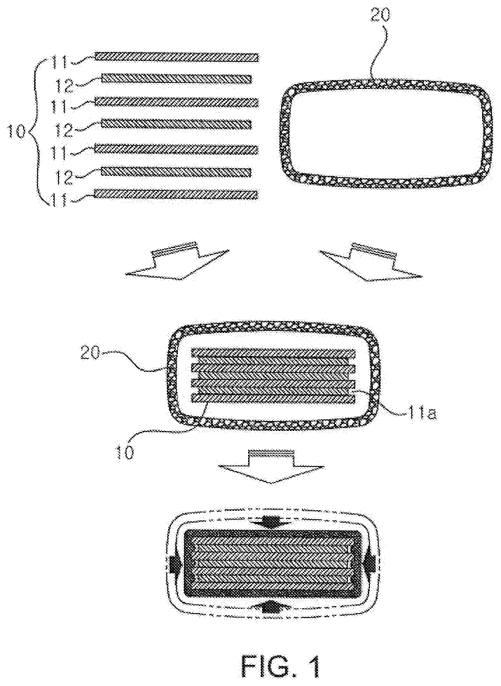

In each of the embodiments illustrated in FIGS. 1, 2 and 4, a flexible busbar using a room temperature shrinkable tube comprises a busbar core 10 formed by laminating and combining a plurality of copper plates and aluminum; and a shrinkable tube 20 which is tubed onto an outer circumferential surface of the busbar core 10, expanded in a range without exceeding a predetermined expansion rate through an aqueous system using a saturated aqueous solution comprising a mixture of water and an expansion agent, and insulated and coated on the outer circumferential surface of the busbar core 10 while being shrunk and tubed at room temperature.

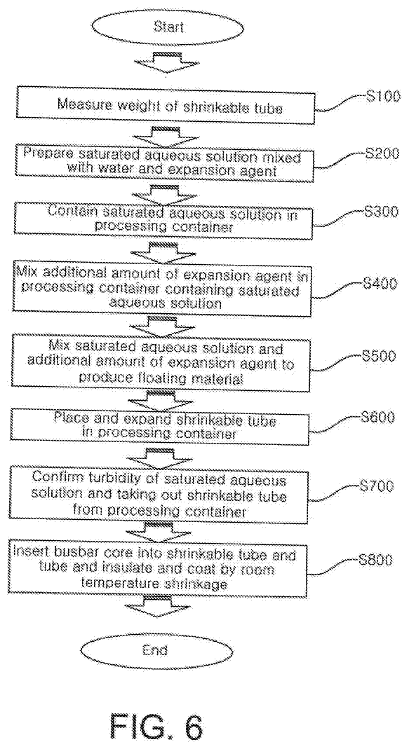

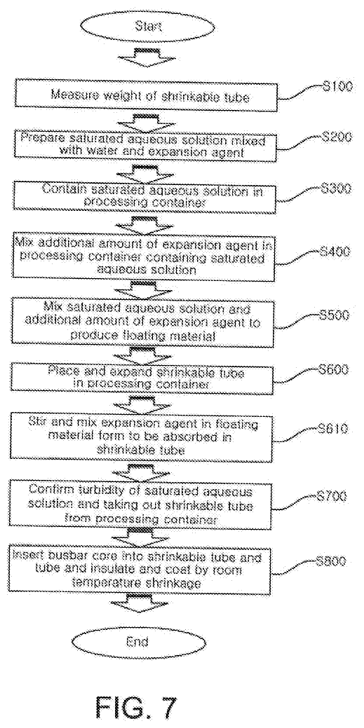

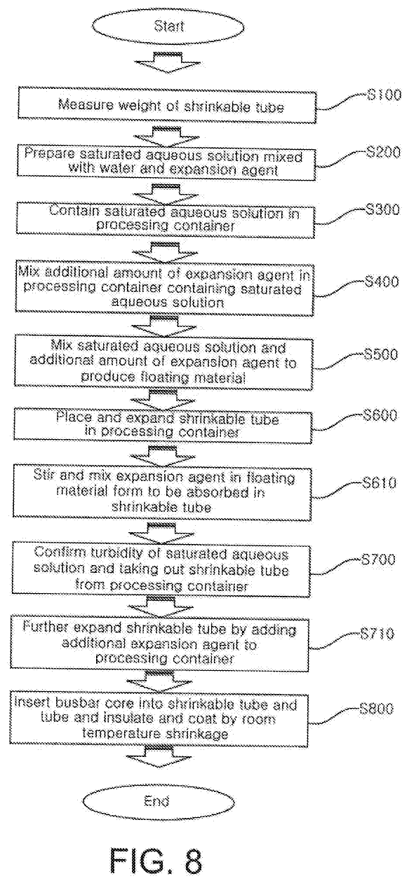

In each of the embodiments illustrated in FIGS. 6, 7 and 8, a method for manufacturing a room temperature shrinkable tube using water and an expansion agent coated on a flexible busbar comprises the steps of: measuring a weight of the shrinkable tube 20 (S100); preparing the saturated aqueous solution in which a predetermined amount of the water and the expansion agent is mixed depending on the measured weight of the shrinkable tube 20 (S200); containing the saturated aqueous solution prepared in step S200 in a processing container (S300); further adding a predetermined additional amount of the expansion agent to the processing container in which the saturated aqueous solution is contained (S400); stirring and mixing the saturated aqueous solution and the additional amount of the expansion agent contained in the processing container to form floating materials (S500); expanding the shrinkable tube 20 through an aqueous system in a range without exceeding the predetermined expansion rate by containing the shrinkable tube 20 in the processing container and absorbing the expansion agent (S600); and inserting the busbar core 10 into the expanded shrinkable tube 20 and tubing the busbar core 10 with room temperature shrinkage to insulate and coat the tubed busbar core 10 (S800).

Hereinafter, embodiments of the present invention will be described in detail with reference to FIGS. 1 to 8.

The present invention relates to a method for manufacturing a room temperature shrinkable tube using water and an expansion agent and a flexible busbar using the same, and is constituted by including a busbar core 10 and a shrinkable tube 20 as main configurations, in which the shrinkable tube is expanded using an aqueous system of immersing and expanding the shrinkable tube in a solution comprising a mixture of water and an expansion agent for a predetermined time, the expanded shrinkable tube is naturally shrunk at room temperature, and simply tubed onto an outer circumferential surface of a busbar core to be insulated and coated, and in particular, the busbar core maintains the integrity with the shrinkable tube by a structure engaging with an intaglio-relief structure by a shrinkage force of the shrinkable tube so as to prevent deformation including lifting and wrinkling of the shrinkable tube when the shape of the busbar is deformed.

The busbar core 10 according to the present invention is formed by laminating and combining a plurality of plates. According to the present invention, the plurality of plates is preferably formed by laminating and combining copper plates and aluminum materials, but is not limited thereto, and the plates are formed at thicknesses of 0.1 to 1 mm and laminated in multiple layers to form the busbar core 10. At this time, the number of laminated plates is determined in consideration of a voltage capacity. In addition, fastening holes are formed at both ends of the busbar core 10 to be fastened to an electric line in a switchboard. At this time, since the fastening hole is formed in a long hole, even if a difference in end length due to each plate bending radius occurs when the busbar core 10 is bent, the fastening hole is prevented from being blocked.

As such, as the busbar core 10 is formed of a laminated structure of the plurality of plates, even if the busbar core 10 is formed to be thick for high pressure, the busbar core 10 is easily deformed. As a result, the busbar core 10 is molded simply to a desired shape without a separate dedicated tool in the field, so that convenience of construction is provided.

In addition, the shrinkable tube 20 according to the present invention is provided to be tubed on the outer circumferential surface of the busbar core 10, expanded in a range without exceeding a predetermined expansion rate through an aqueous system using a saturated aqueous solution in which water and an expansion agent are mixed, and shrunk at room temperature to be insulated and coated on the outer circumferential surface of the busbar core 10. Here, the aqueous system is a method of expanding the shrinkable tube 20 using the aqueous solution in which a type of expansion agent and water as a carrier for carrying the expansion agent are mixed, and the shrinkable tube 20 is tubed on the outer circumferential surface of the busbar core 10 to be insulated and coated using room temperature shrinkage after expansion. The method of tubing the shrinkable tube 20 accordingly refers to a method for manufacturing a room temperature shrinkable tube using water and an expansion agent.

In addition, when the busbar core 10 and the shrinkable tube 20 are tubed and combined, the busbar core 10 and the shrinkable tube 20 engage with each other in an intaglio-relief structure, and detailed descriptions thereof will be described with reference to FIGS. 1 to 4 to be described below.

In FIG. 1, the busbar core 10 according to an embodiment is constituted by a plurality of base plates 11, spacing plates 12 disposed between the base plates 11 and formed with smaller widths than the base plates 11, and intaglio band portions 11a formed between the base plates 11 due to a difference in lateral size between the base plates 11 and the spacing plates 12.

In addition, the shrinkable tube 20 has relief band portions 21 formed while an inner circumferential surface protrudes into the shapes of the intaglio band portions 11a while being shrunk, and the relief band portions 21 are combined to engage with the intaglio band portions 11a in a plurality of places.

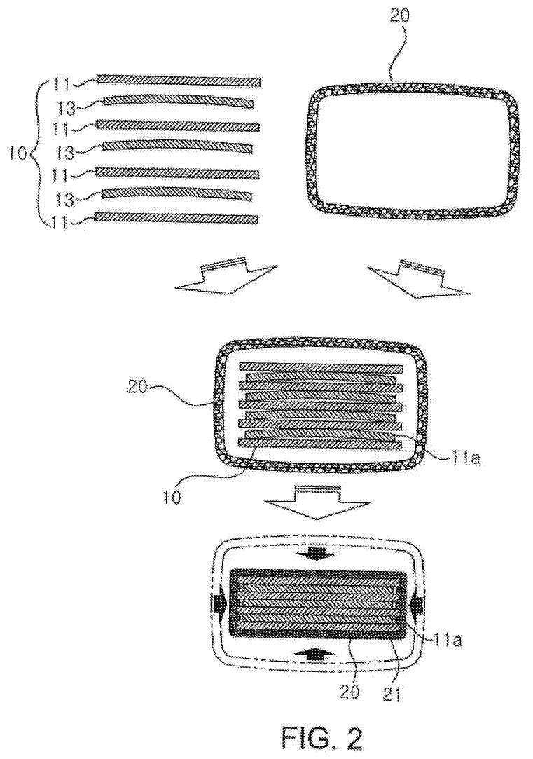

In FIG. 2, the busbar core 10 according to another embodiment is constituted by a plurality of base plates 11, arched spacing plates 13 disposed between the base plates 11 and formed in arch shapes with smaller widths than the base plates 11, and intaglio band portions 11a formed between the base plates 11 due to a difference in lateral size between the base plates 11 and the arched spacing plates 13.

In addition, the shrinkable tube 20 has relief band portions 21 formed while an inner circumferential surface protrudes into the shape of the intaglio band portions 11a while being shrunk, and the relief band portions 21 are combined to engage with the intaglio band portions 11a in a plurality of places.

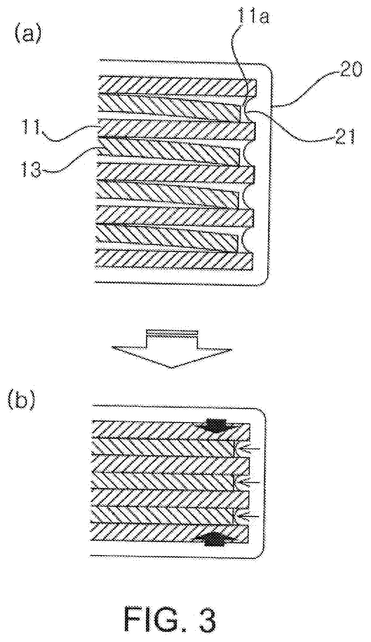

As illustrated in FIG. 3, the base plates 11 are spaced apart from each other at extended gaps with respect to the thickness of the spacing plate 13 by an arched curvature of the arched spacing plate 13. When the busbar core 10 is pressed while the shrinkable tube 20 is shrunk, the gap between the base plates 11 is reduced while the spacing plate 13 is unfolded in a straight line, and due to the reduction in the gap between the base plates 11, the relief band portion 21 engaging with the intaglio band portion 11a is pressed and bound to maintain firmly a fixing force.

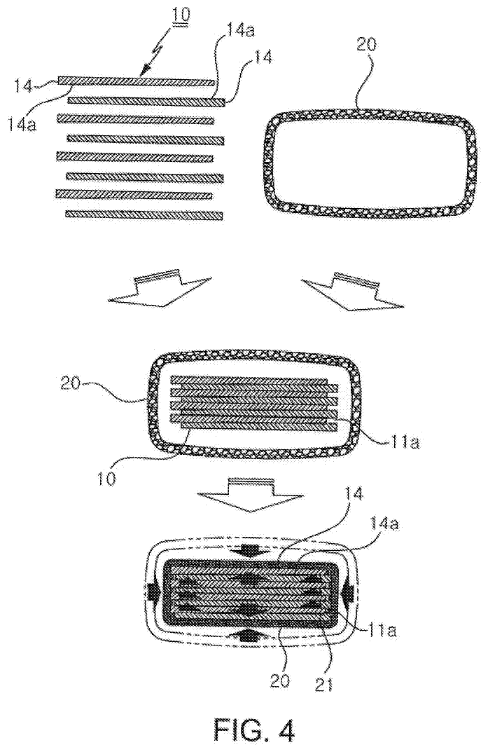

In FIG. 4, the busbar core 10 according to another embodiment is formed by laminating a plurality of wedge-shaped plates 14 with inclined surfaces 14a formed on at least one surface, the wedge-shaped plates 14 are laminated so that the inclined surfaces 14a face each other in opposite directions, and the wedge-shaped plates 14 adjacent to each other in a vertical direction are disposed to be mismatched with each other in a width direction, so that intaglio band portions 11a are formed between the wedge-shaped plates 14.

In addition, when the shrinkable tube 20 is tubed, an inner circumferential surface protrudes into a shape of the intaglio band portion 11a while the shrinkable tube 20 is shrunk to form a relief band portion 21, and the relief band portions 21 are coupled to engage with the intaglio band portions 11a in a plurality of places.

At this time, when the wedge-shaped plate 14 is pressed in both directions by the shrinkage force of the shrinkable tube 20, the expansion force acts in a thickness direction of the busbar core 10 by the inclined motion over the inclined surface 14a so that the wedge-shaped plate 14 is compressed on the inner circumferential surface of the shrinkable tube 20, thereby securing coating airtightness by the shrinkable tube 20.

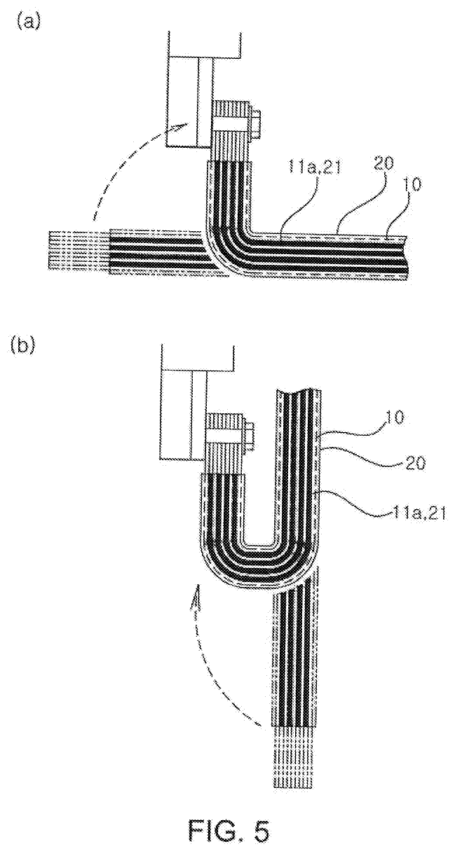

As such, as illustrated in FIGS. 1 to 4, since the busbar core 10 and the shrinkable tube 20 engage with each other in a longitudinal direction of the busbar in a plurality of places by the intaglio band portions 11a and the relief band portions 21, thereby maintaining the integrity. Accordingly, when the busbar is bent and formed in an ‘L’ or ‘C’ shape as illustrated in FIG. 5, the busbar core 10 is more firmly coated and protected while the deformation including lifting and wrinkling of the shrinkable tube 20 is prevented.

Meanwhile, a protrusion protruding toward the intaglio band portion 11a is formed at a position corresponding to both ends of the plate of the busbar core 10 corresponding to the intaglio band portion 11a, so that the relief band portion 21 engaging with the intaglio band portion 11a is provided to be held on the protrusion.

FIGS. 6 to 8 are flowcharts schematically illustrating a method for manufacturing a room temperature shrinkable tube using water and an expansion agent according to the present invention.

A method for manufacturing a room temperature shrinkable tube using water and an expansion agent by tubing the shrinkable tube 20 on an outer circumferential surface of the busbar core 10 to be insulated and coated according to a preferred embodiment of the present invention is constituted by including the steps of: measuring a weight of the shrinkable tube 20 (S100); preparing the saturated aqueous solution in which a predetermined amount of the water and the expansion agent is mixed depending on the measured weight of the shrinkable tube 20 (S200); containing the saturated aqueous solution prepared through step S200 in a processing container (S300); further adding a predetermined additional amount of the expansion agent to the processing container in which the saturated aqueous solution is contained (S400); stirring and mixing the saturated aqueous solution and the additional amount of the expansion agent contained in the processing container to form floating materials (S500); expanding the shrinkable tube 20 through an aqueous system in a range without exceeding the predetermined expansion rate by containing the shrinkable tube 20 in the processing container and absorbing the expansion agent (S600); and inserting the busbar core 10 into the expanded shrinkable tube 20 and tubing the busbar core 10 with room temperature shrinkage to insulate and coat the tubed busbar core 10 (S800).

First, in the method for manufacturing the room temperature shrinkable tube using water and the expansion agent and the flexible busbar using the same in which the shrinkable tube 20 is expanded in a range without exceeding a predetermined expansion rate through the aqueous system using a saturated aqueous solution mixed with the water and the expansion agent and the expanded shrinkable tube 20 is shrunk at room temperature, the method is constituted by the steps of measuring a weight of the shrinkable tube 20 (S100), preparing the saturated aqueous solution in which a predetermined amount of the water and the expansion agent is mixed depending on the measured weight of the shrinkable tube 20 (S200), containing the saturated aqueous solution prepared through step S200 in a processing container (S300), further adding a predetermined additional amount of the expansion agent to the processing container in which the saturated aqueous solution is contained (S400), stirring and mixing the saturated aqueous solution and the additional amount of the expansion agent contained in the processing container to form floating materials (S500), and expanding the shrinkable tube 20 through an aqueous system in a range without exceeding the predetermined expansion rate by containing the shrinkable tube 20 in the processing container and absorbing the expansion agent (S600).

In addition, the step S600 further includes a step S610 of stirring and mixing the expansion agent to be absorbed in the shrinkable tube 20 immersed in the saturated aqueous solution in which the water and the expansion agent are mixed, wherein the step S610 helps to quickly absorb the expansion agent mixed in the saturated aqueous solution in the shrinkable tube 20.

In addition, when the expansion of the shrinkable tube 20 is completed in the step S600, the method further includes a step (S700) of confirming that the expansion of the shrinkable tube 20 is completed by using the turbidity of the saturated aqueous solution in which an additional amount of expansion agent is mixed and taking out the shrinkable tube 20 in which the expansion is completed from the processing container. That is, when the expansion agent mixed in the saturated aqueous solution is fully absorbed in the shrinkable tube 20 and the saturated aqueous solution becomes transparent, it is meant that the expansion agent is fully absorbed, thereby confirming that the expansion of the shrinkable tube 20 is completed.

That is, in the method for manufacturing the room temperature shrinkable tube using the water and the expansion agent according to the present invention and the flexible busbar using the same, the shrinkable tube 20 is expanded by the water and the expansion agent at room temperature by the aqueous system using the water and the expansion agent and the shrinkable tube 20 in which the expansion is completed is taken out and left at room temperature to be automatically shrunk.

Further, according to another embodiment of the present invention, in the step S700, when the shrinkable tube 20 needs to be further expanded at a predetermined expansion rate, the step S700 further includes a step (S710) of further adding an expansion agent to the saturated aqueous solution so that the shrinkable tube 20 is further expanded and placing and expanding the shrinkable tube 20 in the saturated aqueous solution in which the additional expansion agent is added.

Here, in the step S710, an amount X of the expansion agent to be additionally added to the saturated aqueous solution is acquired using the following Equation 1 to have an expansion rate % Z at which the shrinkable tube 20 is further expanded at a predetermined expansion rate % Y.

It is obtained by using the following equation 1:

X=(0.96*Z)/Y−0.96

Here, according to the present invention, in the step S200, the predetermined amount of saturated aqueous solution is preferably prepared as 22 L of a saturated aqueous solution in which water and an expansion agent per 1 kg of weight of the shrinkable tube 20 are mixed. However, the amount is not limited thereto, and the shrinkable tube 20 may be manufactured by adjusting a predetermined amount of aqueous solution depending on the room temperature of a place where the shrinkable tube 20 is expanded.

In addition, in the step S400, the additional amount of the expansion agent to be added to the saturated aqueous solution is set at a ratio of 0.96 L of the expansion agent per 1 kg of the weight of the shrinking tube 20, and, if it is desired that the expansion rate of the shrinking tube 20 should be increased for any reason, an amount of expansion agent calculated at the above ratio is added to the saturated aqueous solution.

Here, in the step S400, 35 ml of silicone oil per 1 kg of the weight of the shrinkable tube 20 may be further added to the additional amount of the expansion agent to be added to the saturated aqueous solution to prevent the shrinkable tube 20 in which the expansion is completed from being slightly sticky and have an effect of smoothing the surface.

In addition, according to the present invention, it is preferable that the predetermined expansion rate of the shrinkable tube 20 be not greater than 30%, but is not limited thereto, and the expansion rate of the shrinkable tube 20 may be set differently as necessary.

Meanwhile, the shrinkable tube 20 used in the present invention uses a shrinkable tube 20 formed by containing at least one of a thermoplastic elastomer (TPE), silicone, and an ethylene vinyl acetate copolymer (EVA).

Here, in the aqueous system of the present invention, any one of methylene chloride, ethyl acetate, and methyl ethyl ketone may be selected used as the expansion agent, and when using methylene chloride as the expansion agent, it is preferable to mix and use a silicone oil SP-760 product in a predetermined amount with methylene chloride.

The shrinkable tube 20 manufactured by the method for manufacturing the room temperature shrinkable tube using the water and the expansion agent according to the present invention may be used, for example, to be coated on an electric wire or a busbar, and it is preferable to use a shrinkable tube 20 in which a diameter of the shrinkable tube 20 before expansion by the expansion agent is smaller than the diameter of an object to be inserted therein.

On the other hand, as the saturated aqueous solution mixed with the water and the expansion agent used in the method for manufacturing the room temperature shrinkable tube using the water and the expansion agent according to the present invention, it is preferred to use an aqueous solution in which 94% of water and 6% of the expansion agent are mixed based on the volume of the saturated aqueous solution at room temperature of 24° C. However, the present invention is not limited thereto, and the amount of the water and the expansion agent may be recalculated and used according to a change in room temperature (indoor temperature).

Subsequently, hereinafter, a process of expanding the shrinkable tube 20 by applying the shrinking tube 20 in method for manufacturing the room temperature shrinkable tube using the water and the expansion agent according to the present invention to the aqueous system will be described in detail.

The aqueous system is a system of immersing and absorbing the tube in a plasticizer to improve flexibility and elasticity, and has a difference from an AirShrink system as a shrinkable tube expansion system in the related art in that the room temperature shrinkable tube is manufactured only using water and an expansion agent.

The aqueous system of the present invention is significantly different from the AirShrink system or an SVM system (hereinafter referred to as an existing system) using two types of expansion agents for PVC and an expansion agent and a diluent in the SVM system.

First, in the existing system, the shrinkable tube is immersed in an aqueous solution mixed with two chemicals. In addition, in this aqueous solution, a suitable pre-calculated plasticizer is mixed to prevent the release of the plasticizer in a PVC material of the shrinkable tube.

In addition, in the existing system, the amount of the expansion agent excessively exceeds the amount required for suitable expansion of the shrinkable tube. This facilitates rapid adsorption of the tube and agents with the properties of the expansion agent. Therefore, it is possible to reach an ideal level of expansion within a convenient time and to stabilize the tube.

Unlike the existing system, there are only two main components in the aqueous system according to the present invention. That is, the two components are an expansion agent and water for expansion of the shrinkable tube, and the water serves as a carrier for the expansion agent.

Here, the most ideal expansion agent in the aqueous system according to the embodiment of the present invention is ethyl acetate. However, methyl ethyl ketone instead of ethyl acetate may be used.

First, as the method of expanding the shrinkable tube 20 using the aqueous system according to the present invention, when the amount of the expansion agent to be used for once expansion of the shrinkable tube 20 is pre-calculated to be an ideal expansion degree when the expansion agent is fully or almost absorbed, and as the expansion agent, ethyl acetate is used due to a low solubility in water.

Here, when the aqueous solution is saturated, only a small amount of about 6% by volume at room temperature is dissolved in water. Accordingly, when a predetermined amount or more of the expansion agent is added to the saturated aqueous solution, the expansion agent is left with extra and then directly reacts to the shrinkable tube 20 to be subsequently processed. In addition, if the reaction is left as it is after adding the extra expansion agent, a new layer is formed on the surface of the saturated aqueous solution because the density of ethyl acetate is lower than that of water.

In addition, before the shrinkable tube 20 is added, the extra expansion agent will be mixed strongly to make floating materials of fine and small bubbles in the solution, which causes the aqueous system to exhibit a characteristic turbidity.

Here, if the shrinkable tube 20 is immersed in the floating material in constant shaking, the shrinkable tube 20 is continuously shocked by the expansion agent and the floating materials, the floating materials are absorbed. Since the concentration of the expansion agent is very low in the saturated aqueous solution, the direct absorption from the saturated aqueous solution by molecular diffusion is also very low and almost neglected when compared with the absorption from the bubbles.

In this aqueous solution, the pre-calculated amount of the expansion agent is fully or almost absorbed by the expansion step of the shrinkable tube 20 with the floating materials, the solution becomes transparent by the disappearance of the floating materials, which is an easy indication that means the last step of the reaction. The remaining solution in the processing container essentially becomes a saturated aqueous solution of the expansion agent again. In this step, the degree of expansion of the shrinkable tube 20 in which the expansion is completed may be checked, and if it is desired to be increased for any reason, a pre-calculated additional expansion agent may be appropriately added while shaking again. The reaction is continued until the additional expansion agent has been fully absorbed.

In the aqueous system according to the present invention, the water serves to carry the expansion agent while maintaining the expansion agent in the form of a floating material of fine and small bubbles which is functionally ideal in the aqueous solution mixed with the water and the expansion agent.

In addition, the bubbles are able to uniformly and gradually approach the surface of the shrinkable tube 20, and an important advantage in the aqueous system is non-flammability.

Meanwhile, the aqueous system includes a saturated aqueous solution of ethyl acetate having a predetermined additional amount of ethyl acetate, and the saturated aqueous solution is a solution in an amount sufficient to be effectively mixed at room temperature at 24° C., and the expansion agent is absorbed by the shrinkable tube 20 of approximately 0.56 g/g with the expansion of about 30%.

Here, the saturated aqueous solution of ethyl acetate is 22 L per 1 kg of the weight of the shrinkable tube 20, and an additional amount of ethyl acetate is 0.96 L per 1 kg of the weight of the shrinkable tube 20.

According to another embodiment of the present invention, the aqueous system is mixed with a small amount (about 35 ml per 1 kg of shrinkable tube) of silicone oil (Dow Corning Fluid 550) in an additional amount of ethyl acetate. Such variations are used when the surface of the expanded shrinkable tube 20 is somewhat sticky.

The silicone oil was used to remove this stickiness, and also makes the surface of the shrinkable tube 20 smooth. In addition, the latter effect is helpful when the expanded shrinkable tube 20 is stretched on an object to be shrunk.

In addition, according to yet another embodiment of the present invention, in the aqueous system, a small additional amount of about 5% of ethyl acetate is substituted with amyl acetate to hide the odor of ethyl acetate in the expanded shrinkable tube 20, and as a result of using the following mixed solution instead of 0.96 L of ethyl acetate for 1 kg of the shrinkable tube 20, a considerable effect in hiding the smell is exhibited.

In the aqueous system according to yet another embodiment of the present invention, 0.915 L of ethyl acetate and 45 ml of ethyl acetate per 1 kg of the shrinkable tube 20 are used, an unique odor of amyl acetate in the mixed solution has a dominant effect on the expanded shrinkable tube 20 and is maintained for some time even after shrinking.

Here, the acetate serves as an expansion agent for expansion of the shrinkable tube 20, but is not suitable due to its relatively low volatility. Therefore, it is shown that amyl acetate is used, and a substitute capable of duplicating the expansion process will greatly lower a continuous shrinkage and persists a residual odor of the reagent.

In the method for manufacturing the room temperature shrinkable tube using the water and the expansion agent of the present invention, the process of expanding a single amount of the shrinkable tube 20 using the aqueous system is as follows.

First, a single amount to be used to expand the shrinkable tube 20 is measured and written.

Thereafter, an amount of a saturated ethyl acetate aqueous solution required to expand the single amount of the shrinkable tube 20 is prepared. Here, the aqueous solution is 22 L per 1 kg of tubing, and a large amount of an aqueous solution to be used for expansion of the shrinkable tube 20 may be prepared in advance and stored, and an aqueous solution prepared according to another embodiment of the present invention may be used.

Thereafter, the aqueous solution is contained in a container having a sufficient size to handle the expansion of the single amount of the shrinkable tube 20. After the expansion agent is placed in the container, the expansion agent needs to be properly prepared to strongly mix the contents in the container so that excess ethyl acetate bubble floating materials are sufficiently formed and maintained.

Here, if all other conditions are appropriate, it is sufficient to simply shake an experimental vessel when mixing the solution.

Subsequently, a pre-calculated amount of ethyl acetate is added to the saturated aqueous solution, and the mixed solution is mixed to produce a floating material. Then, the measured amount of the shrinkable tube 20 is added.

Here, it should be noted that the expansion of the shrinkable tube 20 does not directly react with excess ethyl acetate other than the floating bubbles. For example, when reacting with the expansion agent layer on the surface of the aqueous solution (saturated aqueous solution), partially excessive absorption may occur, such that the shrinkable tube 20 is excessively expanded or the shape thereof is distorted. At the same time, this reduces the amount of ethyl acetate that needs to be uniformly absorbed from the floating material.

The reactions of the above process and the methods of continuous management are various, but depend on a method of mixing with a specific format of the process. For example, in a large-scale manufacturing process, a measured amount of the shrinkable tube 20 is first added in a container, and the floating material is mixed by a method of pouring from an auxiliary container into the main container. Thus, the circulation of the floating material is started, and the continuous circulation helps the bubbles floating in the solution to be in uniform contact with the shrinkable tube 20, and the floating material is maintained by shaking.

Next, the process continues until all or almost all of the ethyl acetate bubbles in a predetermined amount are absorbed into the shrinkable tube 20, that is, until the saturated aqueous solution in reaction is transparent, and the processing time is about 50.

When the saturated aqueous solution becomes transparent, the degree of expansion of the shrinkable tube 20 is confirmed by measurement. In addition, if the expansion is further required, a small predetermined amount of ethyl acetate is further added in the form of a floating material. Then, the reaction continues until the solution becomes transparent again. An example below shows how to measure the additional amount of expansion agent.

First, in the method of measuring the additional amount of the expansion agent, since the calculation is rough, first a half of the calculated amount is first added, and then the additional expansion is measured when the solution in the container becomes transparent. If the additional expansion is not sufficient, the other half of the expansion agent is added.

In the method for measuring the additional amount of the expansion agent, first, the expansion rate of the shrinkable tube 20 is about 30% during the main processing process of the water and the expansion agent that are components of the aqueous system. Then, the expansion is further performed to have a final expansion rate of 35%.

Here, the amount of additional ethyl acetate used in the components of the aqueous system is 0.96 L of an aqueous solution per 1 Kg of the shrinkable tube 20.

An amount of ethyl acetate (X L per 1 kg of tubing) to be added for 5% expansion after the shrinkable tube 20 is expanded at 30% may be calculated by the following Equation 1.

X=(0.96*Z)/Y−0.96

Finally, after the absorption of the expansion agent into the shrinkable tube 20 is completed, that is, when the saturated ethyl acetate in the saturated aqueous solution becomes transparent again, the shrinkable tube 20 needs to be taken out of the processing container as soon as possible.

The reason is that if the shrinkable tube to be expanded is immersed for a relatively short time at room temperature, the water absorption caused by this is slight. However, when the shrinkable tube 20 is immersed for a long time after being expanded by the expansion agent, water penetrates into the material, which damages the finish of the surface of the shrinkable tube 20 and interferes with the final shrinkage in air.

Replenishment of the processing container in the aqueous system of the present invention is simple and easy, and performed in the following order for each amount of tubes to be processed.

After the pre-processed shrinkable tube 20 is removed from the processing container, the saturated ethyl acetate aqueous solution is immersed in the container. Therefore, in theory, it is sufficient to add the amount of ethyl acetate required to process the expansion of a next shrinkable tube 20, but in practice, when the shrinkable tube 20 is taken out of the processing container, it should be taken into account for a certain amount of aqueous solution that is lost while attached on the surface of the shrinkable tube 20 or not removed from the inside of the shrinkable tube 20. If this part is not replenished, the effect of this loss of the aqueous solution will reduce the proportion of the solution in the expansion process of the next shrinkable tube 20. Therefore, if the lost amount is a significant amount to cause a significant change, it is necessary to replenish the equipment and a required amount according to the expansion of the shrinkable tube 20 so that an original amount (solution ratio of 22 L/kg) is filled.

Here, the solution plays an important role as a carrier of excess ethyl acetate, but since the solution does not directly participate in expansion, the practical importance of the solution ratio is only a problem in terms of convenience of the processing process.

Therefore, the solution may be easily replenished to be a first amount by displaying an optimum amount in the processing container or the auxiliary container.

As can be seen from the foregoing contents, the aqueous system according to the present invention has significantly different operational features in concept or application from the existing system.

First, the aqueous system according to the present invention has features that an inexpensive and non-toxic solution (water) is used as a medium for processing or as a carrier of the expansion agent, a pre-calculated (defined) amount of only one expansion agent is used for a required degree of expansion of the shrinkable tube 20 (the amount is not exceeded as in the existing systems), and the degree of expansion of the shrinkable tube 20 may be closely checked and managed.

Therefore, main advantages of the aqueous system according to the embodiment of the present invention are as follows.

First, the aqueous system increases operational stability and convenience due to the use of only one type of expansion agent in combination with a safe and inexpensive carrier, and there is no prohibition or limitation on the use of the expansion agent, and the degree of expansion of the shrinkable tube 20 through the use of a pre-calculated and measured amount of expansion agent may be directly and closely managed.

In addition, it is not required to maintain the economic performance of the expansion agent and the balance of the plasticizer in the processing container, a minimum risk of ignition is prevented, and there are the ease and simplicity of replenishing the saturated aqueous solution in the processing container.

The shrinkable tube 20 manufactured by the method for manufacturing the room temperature shrinkable tube using the water and the expansion agent as described above is naturally shrunk at room temperature without a separate shrinking process of the shrinkable tube 20, and for example, the shrinkable tube 20 is naturally shrunk at room temperature and may be used to coat the outer circumferential surface of a conductor.

As described above, in the method for manufacturing the room temperature shrinkable tube using the water and the expansion agent according to the present invention and the flexible busbar using the same, according to the embodiment of the present invention, since the shrinkable tube is expanded using the aqueous system in which a predetermined amount of water and only a type of expansion agent are mixed at room temperature, it is possible to expand the shrinkable tube 20 at a predetermined appropriate expansion rate. In addition, since water is used as a carrier for the expansion agent, there is an advantage of reducing manufacturing costs, and since water, which is a non-toxic solution, is used as a carrier of the expansion agent, there is an advantage that an operator may accurately check and manage the degree of expansion of the shrinkable tube 20 when expanding the shrinkable tube 20.

A description of the present invention is merely an embodiment for a structural or functional description and the scope of the present invention should not be construed as being limited by an embodiments described in the specification.

That is, since the embodiment can be variously changed and have various forms, the scope of the present invention should be understood to include equivalents capable of realizing the technical spirit. Further, it should be understood that since a specific embodiment should include all objects or effects or include only the effect, the scope of the present invention is limited by the object or effect.

Further, meanings of terms described in the present application should be understood as follows. The terms “first,” “second,”, and the like are used to differentiate a certain component from other components, but the scope of the present invention should not be construed to be limited by the terms. For example, a first component may be referred to as a second component, and similarly, the second component may be referred to as the first component.

It should be understood that, when it is described that a component is “connected to” the other component, the component may be directly connected to the other component or another component may be present therebetween. On the other hand, it should be understood that no component exists. Meanwhile, other expressions describing the relationship between the components, that is, expressions such as “between” and “directly between” or “adjacent to” and “directly adjacent to” should be similarly interpreted.

It is to be understood that the singular expression encompass plural expression unless the context clearly dictates otherwise and it should be understood that term “include” or “have” indicates that a feature, a number, a step, an operation, a component, a part or a combination thereof described in the specification is present, but does not exclude a possibility of presence or addition of one or more other features, numbers, steps, operations, components, parts or combinations thereof, in advance.

Although the present invention has been described by the limited embodiments and drawings, the present invention is not limited to the embodiments and various modifications and transformations can be made by those skilled in the art from the disclosure. Therefore, the spirit of the present invention should be construed based on the following claims and all equivalents or equivalent modifications thereto should be construed as falling within the scope of the spirit of the present invention.

### INDUSTRIAL APPLICABILITY

The present invention is not limited to the specific preferred embodiments described above, and without departing from the gist of the invention as claimed in the appended claims, and of course, various modifications can be implemented by anyone of ordinary skill in the art to which the invention pertains and are included within the scope of the claims for technical ideas to form these modifications.

1. A flexible busbar using a room temperature shrinkable tube comprising:
a busbar core formed by laminating and combining a plurality of copper plates and aluminum; and
a shrinkable tube which is provided to be tubed on an outer circumferential surface of the busbar core, expanded in a range without exceeding a predetermined expansion rate through an aqueous system using a saturated aqueous solution mixed with water and an expansion agent, and insulated and coated on the outer circumferential surface of the busbar core while being shrunk and tubed at room temperature;
wherein the busbar core is constituted by a structure from the group consisting of:
a structure wherein the busbar core is constituted by a plurality of base plates, spacing plates disposed between the base plates and formed with smaller widths than the base plates, and intaglio band portions formed between the base plates due to a difference in lateral size between the base plates and the spacing plates, and the shrinkable tube has relief band portions formed while an inner circumferential surface protrudes into the shapes of the intaglio band portions while being shrunk, and the relief band portions are combined to engage with the intaglio band portions in multiple places,
a structure wherein the busbar core is constituted by a plurality of base plates, arched spacing plates disposed between the base plates and formed in arch shapes with smaller widths than the base plates, and intaglio band portions formed between the base plates due to a difference in lateral size between the baseplates and the arched spacing plates, the shrinkable tube has relief band portions formed while an inner circumferential surface protrudes into the shape of the intaglio band portions while being shrunk, wherein the relief band portions are combined to engage with the intaglio band portions in multiple places, and the base plates are spaced apart from each other at extended gaps with respect to the thickness of the spacing plate by an arched curvature of the arched spacing plate, when the busbar core is pressed while the shrinkable tube is shrunk, the gap between the base plates is reduced while the spacing plate is unfolded in a straight line, and due to the reduction in the gap between the base plates, the relief band portion engaging with the intaglio band portion 11a is pressed and bound, and
a structure wherein the busbar core is formed by laminating a plurality of wedge-shaped plates with inclined surfaces 14a formed on at least one surface, wherein the wedge-shaped plates are laminated so that the inclined surfaces face each other in opposite directions and the wedge-shaped plates adjacent to each other in a vertical direction are disposed to be mismatched with each other in a width direction, so that intaglio band portions 11a are formed between the wedge-shaped plates, an inner circumferential surface protrudes into shapes of the intaglio band portions 11a while the shrinkable tube 20 is shrunk to form relief band portions, wherein the relief band portions are coupled to engage with the intaglio band portions in multiple places, and when the wedge-shaped plate is pressed in both directions by the shrinkage force of the shrinkable tube, the expansion force acts in a thickness direction of the busbar core by the inclined motion over the inclined surface so that the wedge-shaped plate is compressed on the inner circumferential surface of the shrinkable tube.

2-15. (canceled)

16. The flexible busbar according to claim 1, wherein, in the saturated aqueous solution, the expansion agent is an agent taken from the group consisting of methylene chloride, ethyl acetate, and methyl ethyl ketone.

17. The flexible busbar according to claim 1, wherein the saturated aqueous solution is 22 L per 1 kg of the shrinkable tube 20, and the expansion agent is 0.96 L per 1 kg of the shrinkable tube 20.

18. A method for manufacturing a flexible busbar using a room temperature shrinkable tube to be insulated and coated by tubing the shrinkable tube on an outer circumferential surface of a busbar core of claim 1, the method comprising the steps of:
measuring a weight of the shrinkable tube;
preparing the saturated aqueous solution in which a predetermined amount of the water and the expansion agent is mixed depending on the measured weight of the shrinkable tube;
containing the saturated aqueous solution prepared in preceding step in a processing container;
further adding a predetermined additional amount of the expansion agent to the processing container in which the saturated aqueous solution is contained;
stirring and mixing the saturated aqueous solution and the additional amount of the expansion agent contained in the processing container to form floating materials;
expanding the shrinkable tube through an aqueous system in a range without exceeding said predetermined expansion rate by containing the shrinkable tube in the processing container and absorbing the expansion agent; and
inserting the busbar core into the expanded shrinkable tube and tubing the busbar core with room temperature shrinkage to insulate and coat the tubed busbar core.

19. The method according to claim 18, wherein step of expanding the shrinkable tube further comprises stirring and mixing the expansion agent in the floating material form to be absorbed in the shrinkable tube immersed in the saturated aqueous solution in which the water and the expansion agent are mixed.

20. The method according to claim 19, further comprising checking that the expansion of the shrinkable tube is completed in step of expanding the shrinkable tube by using the turbidity of the saturated aqueous solution in which an additional amount of expansion agent is mixed, and taking out the shrinkable tube in which the expansion is completed from the processing container.

21. A method for manufacturing a room temperature shrinkable tube using water and an expansion agent in which a shrinkable tube is expanded by an aqueous system of expanding the shrinkable tube using an aqueous solution comprising an expansion agent and water as a carrier for carrying the expansion agent, and the expanded shrinkable tube is shrunk at room temperature, the method comprising the steps of:
measuring weight of the shrinkable tube formed by containing at least one of a thermoplastic elastomer (TPE), silicone, and an ethylene vinyl acetate copolymer (EVA);
preparing a saturated aqueous solution in which 22 L of the water 1 per 1 kg of the weight of the shrinkable tube and the expansion agent are mixed, wherein the saturated aqueous solution consists of 94% of the water 1 and 6% of the expansion agent based on the volume at room temperature of 24° C.;
containing the saturated aqueous solution prepared in the preceding step in a processing container;
further adding an additional amount of the expansion agent prepared as 0.96 L of the expansion agent per 1 kg of the weight of the shrinkable tube to the processing container in which the saturated aqueous solution consisting of the water and the expansion agent is contained, and adding Dow Corning Fluid 550 silicone oil prepared at 35 ml per 1 kg of the weight of the shrinkable tube 100;
stirring and mixing the additional amount of the expansion agent to the saturated aqueous solution so that the additional amount of the expansion agent added to the saturated aqueous solution is in the form of a floating material and the expansion agent is maintained and circulated in the floating material in the form of bubbles to form floating materials;
expanding the shrinkable tube in a range without exceeding the predetermined expansion rate by containing the shrinkable tube in the processing container so that the expansion agent in the floating material form is in contact with the shrinkable tube;
stirring and mixing the expansion agent in the floating material form and the shrinkable tube so the expansion agent formed in the floating material in the form of bubbles is in uniform contact with the shrinkable tube and absorbed by absorbing and expanding the expansion agent in the shrinkable tube;
checking that the expansion of the shrinkable tube is completed through the turbidity of the saturated aqueous solution, and taking out the shrinkable tube in which the expansion is completed from the processing container; and
further expanding the shrinkable tube by further adding the expansion agent prepared in a floating material form to the processing container when the shrinkable tube in which the expansion is completed in the preceding checking step needs to be further expanded at a predetermined expansion rate.

22. The method according to claim 21, wherein in said checking step, an amount X of the expansion agent to be additionally added to the saturated aqueous solution is acquired using the equation X=(0.96*Z)/Y−0.96 to have an expansion rate % Z at which the shrinkable tube is further expanded at a predetermined expansion rate % Y.

23. The method according to claim 21, wherein the predetermined expansion rate of the shrinkable tube is not more than 30%.

24. The method according to claim 21, wherein the expansion agent is an agent from the group consisting of ethyl acetate and methyl ethyl ketone.

25. The method according to claim 21, wherein an object is inserted into the shrinkable tube, and wherein the diameter of the shrinkable tube before expansion by the expansion agent is smaller than the diameter of the object to be inserted into the shrinkable tube.
